(19) United States
(12) Patent Application Publication
(10) Pub. No.: US 2023/0342223 A1
(43) Pub. Date: Oct. 26, 2023

(54) EDGE RESOURCE MANAGEMENT

(71) Applicants: Francesc Guim Bernat, Barcelona (ES); Karthik Kumar, Chandler, AZ (US); Marcos E. Carranza, Portland, OR (US); Amruta Misra, Bangalore (IN)

(72) Inventors: Francesc Guim Bernat, Barcelona (ES); Karthik Kumar, Chandler, AZ (US); Marcos E. Carranza, Portland, OR (US); Amruta Misra, Bangalore (IN)

(21) Appl. No.: 18/216,790

(22) Filed: Jun. 30, 2023

(51) Int. Cl. G06F 9/50

(52) U.S. Cl. CPC G06F 9/5088; G06F 9/5072; H04L 67/10

(57) ABSTRACT

Various aspects of methods, systems, and use cases include edge resource management, such as of a processor of an edge device. The edge device may include a processor to execute an application and a device including an interface to the processor and a network interface. The device may include circuitry to monitor a status of the processor; and based on the status and the application having an associated requirement, initiate a migration of execution of the application from the processor.

### BACKGROUND

Edge computing, at a general level, refers to the implementation, coordination, and use of computing and resources at locations closer to the “edge” or collection of “edges” of the network. The purpose of this arrangement is to improve total cost of ownership, reduce application and network latency, reduce network backhaul traffic and associated energy consumption, improve service capabilities, and improve compliance with security or data privacy requirements (especially as compared to conventional cloud computing). Components that can perform edge computing operations (“edge nodes”) can reside in whatever location needed by the system architecture or ad hoc service (e.g., in an high performance compute data center or cloud installation; a designated edge node server, an enterprise server, a roadside server, a telecom central office; or a local or peer at-the-edge device being served consuming edge services).

Applications that have been adapted for edge computing include but are not limited to virtualization of traditional network functions (e.g., to operate telecommunications or Internet services) and the introduction of next-generation features and services (e.g., to support 5G network services). Use-cases which are projected to extensively utilize edge computing include connected self-driving cars, surveillance, Internet of Things (IoT) device data analytics, video encoding and analytics, location aware services, device sensing in Smart Cities, among many other network and compute intensive services.

Edge computing may, in some scenarios, offer or host a cloud-like distributed service, to offer orchestration and management for applications and coordinated service instances among many types of storage and compute resources. Edge computing is also expected to be closely integrated with existing use cases and technology developed for IoT and Fog/distributed networking configurations, as endpoint devices, clients, and gateways attempt to access network resources and applications at locations closer to the edge of the network.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an overview of an edge cloud configuration for edge computing in accordance with some embodiments.

FIG. 2 illustrates operational layers among endpoints, an edge cloud, and cloud computing environments in accordance with some embodiments.

FIG. 3 illustrates an example approach for networking and services in an edge computing system in accordance with some embodiments.

FIG. 4 illustrates deployment of a virtual edge configuration in an edge computing system operated among multiple edge nodes and multiple tenants in accordance with some embodiments.

FIG. 5 illustrates various compute arrangements deploying containers in an edge computing system in accordance with some embodiments.

FIG. 6 illustrates a compute and communication use case involving mobile access to applications in an edge computing system in accordance with some embodiments.

FIG. 7A provides an overview of example components for compute deployed at a compute node in an edge computing system in accordance with some embodiments.

FIG. 7B provides a further overview of example components within a computing device in an edge computing system in accordance with some embodiments.

FIG. 8 illustrates an example edge platform in accordance with some embodiments.

FIG. 9 illustrates an example architecture for an edge platform in accordance with some embodiments.

FIG. 10 illustrates an example system with a virtual bus for edge platform communication in accordance with some embodiments.

FIG. 11 illustrates a flowchart showing a technique for edge resource management in accordance with some embodiments.

FIGS. 12-13 illustrate example architecture for a maintenance telemetry monitoring unit in accordance with some embodiments.

### DETAILED DESCRIPTION

Systems and techniques described herein provide edge resource management. An edge device (e.g., an edge platform) may include an infrastructure processing unit (IPU). The IPU may be used to offload a service or application from a CPU, such as when the CPU loses power (e.g., via maintenance or sudden power loss). The IPU may, in some examples, execute a service or application, effectively replacing the CPU, such as for a brief period of time. In other examples, the IPU may coordinate with a nearby edge device (or a remote edge device or a cloud device) to perform a service or application migration from the CPU. Although an IPU is referred to throughout this disclosure, other devices may be substituted without deviation, or other names may be used to refer to an IPU. These other devices or other names may include an edge processing unit (EPU), a data processing unit (DPU), a smartNIC, an enhanced SmartNIC, a network processing unit (NPU), a graphics processing unit (GPU), a programmed FPGA, or the like.

In an example, the systems and techniques described herein use an interface of an IPU to register an application or service, executing at a CPU. The application or service may include a service level agreement (SLA), such as zero-downtime, low latency, etc. The IPU may include circuitry to monitor a status of the CPU. The IPU may, in response to the status of the CPU being indicative of a failure to comply with the SLA, initiate a migration of the service or application from the CPU to the IPU or other edge device (e.g., by coordinating with an IPU of the other edge device), to execute the application or service according to the SLA (or at least according to an improvement in SLA over the CPU, which may not be operable without power).

A local edge network may include a geographic area, such as all edge devices within a few kilometers. The edge devices in a local edge network, which may also be called a hive or a system, may have different energy profiles, such as having different levels of power supply (e.g., availability of sunlight, availability of wind, etc.) or power availability (e.g., battery charge) throughout a time period, such as a day.

An edge device may use a discovery mechanism, such as via a simple network management protocol (SNMP) to discover peers, or the peers may be specified (e.g., by an orchestrator). The edge device may use a discovery protocol to identify other edge devices and connect, authenticate, and exchange capabilities with these nearby edge devices stations. In some examples, microservice or power availability at peer devices may be updated, such as every day, every minute, every second, or the like. Telemetry data for microservices launched or available or power available or predicted may be provided periodically. In another example, a publish/subscription service may be used. For example, when a peer updates CPU availability, network availability, microservices instantiated, power availability, etc., it may publish an update. An IPU of an edge device in the network may subscribe and receive the published updates from the nearby peer. In some examples, such as for power or battery availability or capacity, an edge device may fetch the information via a publish/subscribe protocol, such as MQTT protocol, data distribution service (DDS), or an M2M communication protocol.

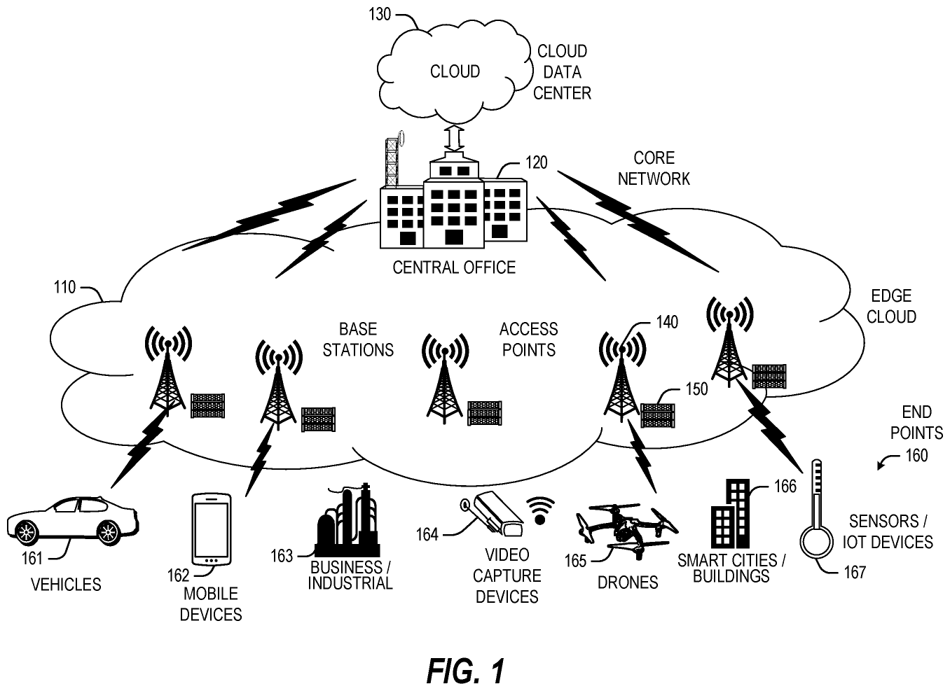

FIG. 1 is a block diagram 100 showing an overview of a configuration for edge computing, which includes a layer of processing referred to in many of the following examples as an “edge cloud”. As shown, the edge cloud 110 is co-located at an edge location, such as an access point or base station 140, a local processing hub 150, or a central office 120, and thus may include multiple entities, devices, and equipment instances. The edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the edge cloud 110 are critical to providing ultra-low latency response times for services and functions used by the endpoint data sources 160 as well as reduce network backhaul traffic from the edge cloud 110 toward cloud data center 130 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

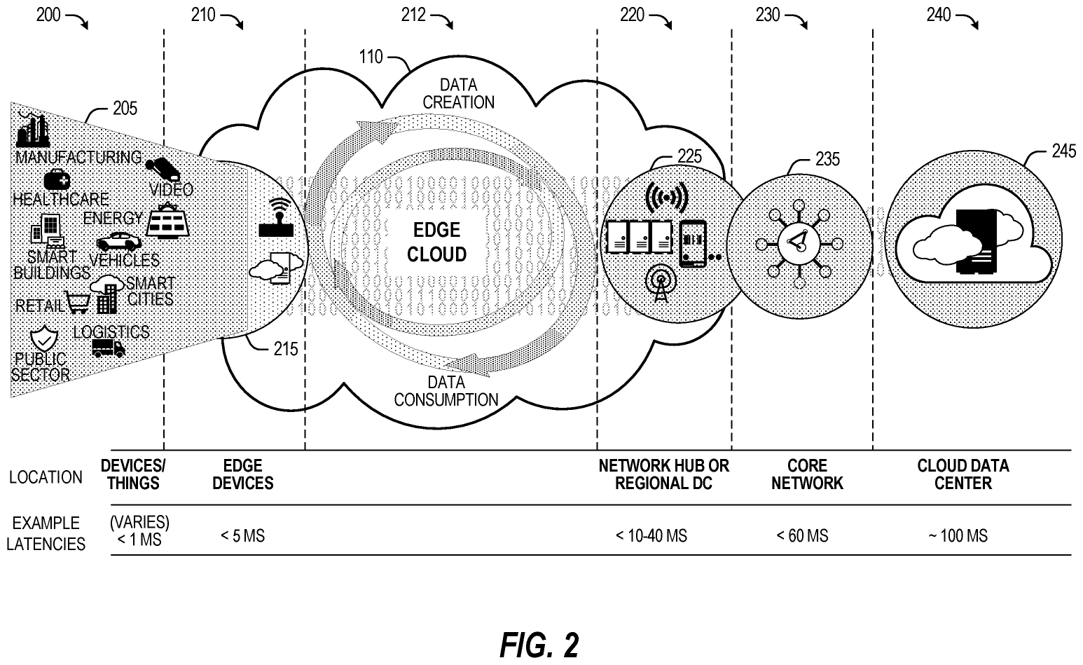

FIG. 2 illustrates operational layers among endpoints, an edge cloud, and cloud computing environments. Specifically, FIG. 2 depicts examples of computational use cases 205, utilizing the edge cloud 110 among multiple illustrative layers of network computing. The layers begin at an endpoint (devices and things) layer 200, which accesses the edge cloud 110 to conduct data creation, analysis, and data consumption activities. The edge cloud 110 may span multiple network layers, such as an edge devices layer 210 having gateways, on-premise servers, or network equipment (nodes 215) located in physically proximate edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the edge cloud 110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 200, under 5 ms at the edge devices layer 210, to even between 10 to 40 ms when communicating with nodes at the network access layer 220. Beyond the edge cloud 110 are core network 230 and cloud data center 240 layers, each with increasing latency (e.g., between 50-60 ms at the core network layer 230, to 100 or more ms at the cloud data center layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 235 or a cloud data center 245, a central office or content data network may be considered as being located within a “near edge” layer (“near” to the cloud, having high latency values when communicating with the devices and endpoints of the use cases 205), whereas an access point, base station, on-premise server, or network gateway may be considered as located within a “far edge” layer (“far” from the cloud, having low latency values when communicating with the devices and endpoints of the use cases 205). It will be understood that other categorizations of a particular network layer as constituting a “close”, “local”, “near”, “middle”, or “far” edge may be based on latency, distance, number of network hops, or other measurable characteristics, as measured from a source in any of the network layers 200-240.

The various use cases 205 may access resources under usage pressure from incoming streams, due to multiple services utilizing the edge cloud. To achieve results with low latency, the services executed within the edge cloud 110 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to service level agreement (SLA), the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 110 (network layers 200-240), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 110.

As such, the edge cloud 110 is formed from network components and functional features operated by and within edge gateway nodes, edge aggregation nodes, or other edge compute nodes among network layers 210-230. The edge cloud 110 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 110 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

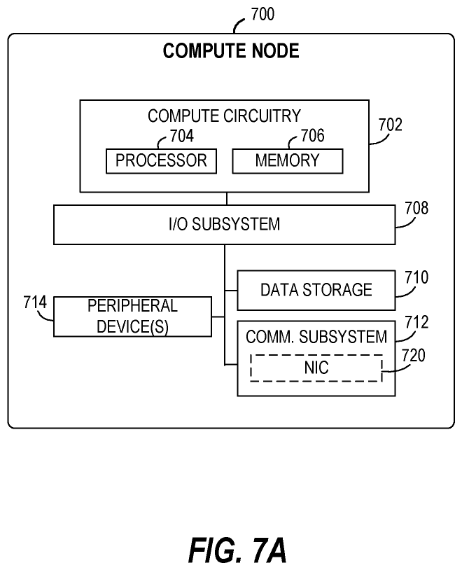

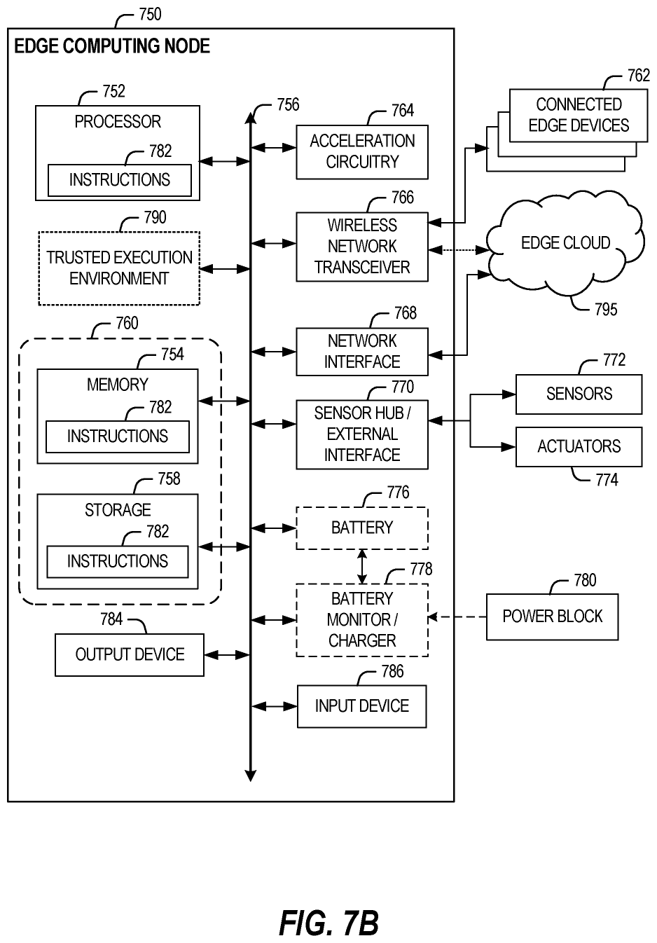

The network components of the edge cloud 110 may be servers, multi-tenant servers, appliance computing devices, and/or any other type of computing devices. For example, the edge cloud 110 may be an appliance computing device that is a self-contained processing system including a housing, case or shell. In some cases, edge devices are devices presented in the network for a specific purpose (e.g., a traffic light), but that have processing or other capacities that may be harnessed for other purposes. Such edge devices may be independent from other networked devices and provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 7B. The edge cloud 110 may also include one or more servers and/or one or more multi-tenant servers. Such a server may implement a virtual computing environment such as a hypervisor for deploying virtual machines, an operating system that implements containers, etc. Such virtual computing environments provide an execution environment in which one or more applications may execute while being isolated from one or more other applications.

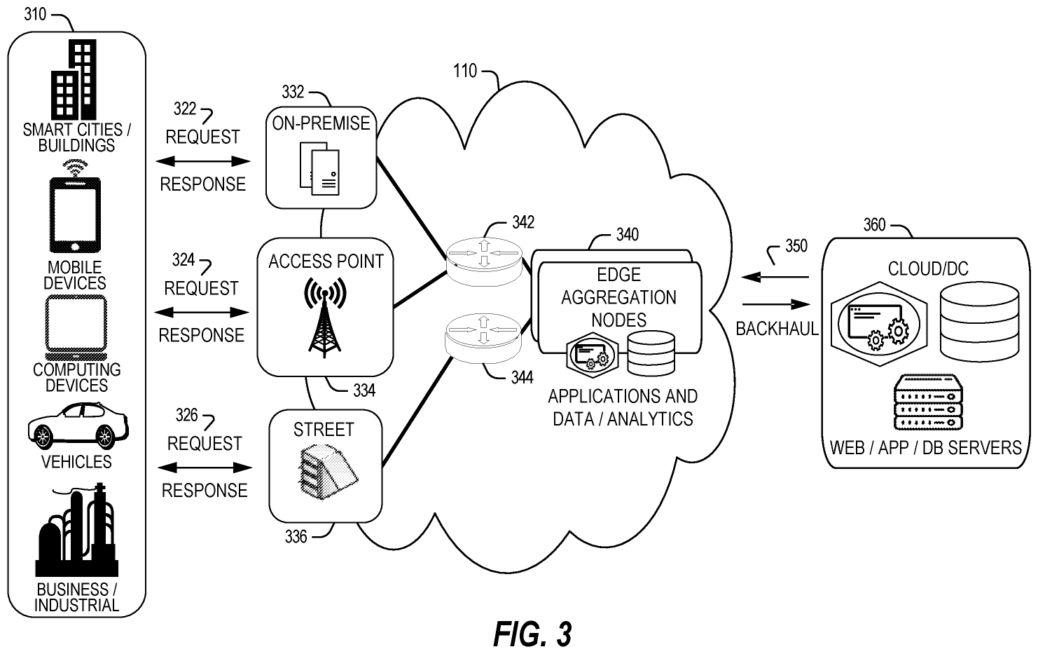

In FIG. 3, various client endpoints 310 (in the form of mobile devices, computers, autonomous vehicles, business computing equipment, industrial processing equipment) exchange requests and responses that are specific to the type of endpoint network aggregation. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the edge cloud 110 to aggregate traffic and requests. Thus, within the edge cloud 110, the TSP may deploy various compute and storage resources, such as at edge aggregation nodes 340, to provide requested content. The edge aggregation nodes 340 and other systems of the edge cloud 110 are connected to a cloud or data center 360, which uses a backhaul network 350 to fulfill higher-latency requests from a cloud/data center for websites, applications, database servers, etc. Additional or consolidated instances of the edge aggregation nodes 340 and the aggregation points 342, 344, including those deployed on a single server framework, may also be present within the edge cloud 110 or other areas of the TSP infrastructure.

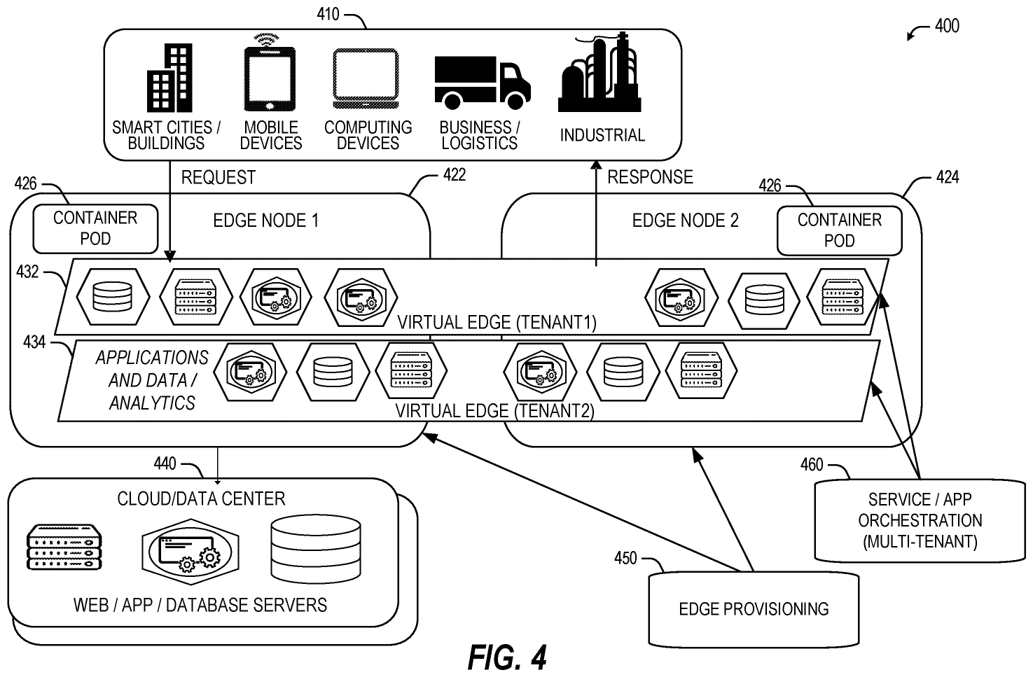

FIG. 4 illustrates deployment and orchestration for virtual edge configurations across an edge computing system operated among multiple edge nodes and multiple tenants. Specifically, FIG. 4 depicts coordination of a first edge node 422 and a second edge node 424 in an edge computing system 400, to fulfill requests and responses for various client endpoints 410 (e.g., smart cities/building systems, mobile devices, computing devices, business/logistics systems, industrial systems, etc.), which access various virtual edge instances. Here, the virtual edge instances 432, 434 provide edge compute capabilities and processing in an edge cloud, with access to a cloud/data center 440 for higher-latency requests for websites, applications, database servers, etc. However, the edge cloud enables coordination of processing among multiple edge nodes for multiple tenants or entities.

In the example of FIG. 4, these virtual edge instances include: a first virtual edge 432, offered to a first tenant (Tenant 1), which offers a first combination of edge storage, computing, and services; and a second virtual edge 434, offering a second combination of edge storage, computing, and services. The virtual edge instances 432, 434 are distributed among the edge nodes 422, 424, and may include scenarios in which a request and response are fulfilled from the same or different edge nodes. The configuration of the edge nodes 422, 424 to operate in a distributed yet coordinated fashion occurs based on edge provisioning functions 450. The functionality of the edge nodes 422, 424 to provide coordinated operation for applications and services, among multiple tenants, occurs based on orchestration functions 460.

It should be understood that some of the devices in 410 are multi-tenant devices where Tenant 1 may function within a tenant1 ‘slice’ while a Tenant 2 may function within a tenant2 slice (and, in further examples, additional or sub-tenants may exist; and each tenant may even be specifically entitled and transactionally tied to a specific set of features all the way day to specific hardware features). A trusted multi-tenant device may further contain a tenant specific cryptographic key such that the combination of key and slice may be considered a “root of trust” (RoT) or tenant specific RoT. A RoT may further be computed dynamically composed using a DICE (Device Identity Composition Engine) architecture such that a single DICE hardware building block may be used to construct layered trusted computing base contexts for layering of device capabilities (such as a Field Programmable Gate Array (FPGA)). The RoT may further be used for a trusted computing context to enable a “fan-out” that is useful for supporting multi-tenancy. Within a multi-tenant environment, the respective edge nodes 422, 424 may operate as security feature enforcement points for local resources allocated to multiple tenants per node. Additionally, tenant runtime and application execution (e.g., in instances 432, 434) may serve as an enforcement point for a security feature that creates a virtual edge abstraction of resources spanning potentially multiple physical hosting platforms. Finally, the orchestration functions 460 at an orchestration entity may operate as a security feature enforcement point for marshalling resources along tenant boundaries.

Edge computing nodes may partition resources (memory, central processing unit (CPU), graphics processing unit (GPU), interrupt controller, input/output (I/O) controller, memory controller, bus controller, etc.) where respective partitionings may contain a RoT capability and where fan-out and layering according to a DICE model may further be applied to Edge Nodes. Cloud computing nodes consisting of containers, FaaS engines, Servlets, servers, or other computation abstraction may be partitioned according to a DICE layering and fan-out structure to support a RoT context for each. Accordingly, the respective RoTs spanning devices 410, 422, and 440 may coordinate the establishment of a distributed trusted computing base (DTCB) such that a tenant-specific virtual trusted secure channel linking all elements end to end can be established.

Further, it will be understood that a container may have data or workload specific keys protecting its content from a previous edge node. As part of migration of a container, a pod controller at a source edge node may obtain a migration key from a target edge node pod controller where the migration key is used to wrap the container-specific keys. When the container/pod is migrated to the target edge node, the unwrapping key is exposed to the pod controller that then decrypts the wrapped keys. The keys may now be used to perform operations on container specific data. The migration functions may be gated by properly attested edge nodes and pod managers (as described above).

In further examples, an edge computing system is extended to provide for orchestration of multiple applications through the use of containers (a contained, deployable unit of software that provides code and needed dependencies) in a multi-owner, multi-tenant environment. A multi-tenant orchestrator may be used to perform key management, trust anchor management, and other security functions related to the provisioning and lifecycle of the trusted ‘slice’ concept in FIG. 4. For instance, an edge computing system may be configured to fulfill requests and responses for various client endpoints from multiple virtual edge instances (and, from a cloud or remote data center). The use of these virtual edge instances may support multiple tenants and multiple applications (e.g., augmented reality (AR)/virtual reality (VR), enterprise applications, content delivery, gaming, compute offload) simultaneously. Further, there may be multiple types of applications within the virtual edge instances (e.g., normal applications; latency sensitive applications; latency-critical applications; user plane applications; networking applications; etc.). The virtual edge instances may also be spanned across systems of multiple owners at different geographic locations (or, respective computing systems and resources which are co-owned or co-managed by multiple owners).

For instance, each edge node 422, 424 may implement the use of containers, such as with the use of a container “pod” 426, 428 providing a group of one or more containers. In a setting that uses one or more container pods, a pod controller or orchestrator is responsible for local control and orchestration of the containers in the pod. Various edge node resources (e.g., storage, compute, services, depicted with hexagons) provided for the respective edge slices 432, 434 are partitioned according to the needs of each container.

With the use of container pods, a pod controller oversees the partitioning and allocation of containers and resources. The pod controller receives instructions from an orchestrator (e.g., orchestrator 460) that instructs the controller on how best to partition physical resources and for what duration, such as by receiving key performance indicator (KPI) targets based on SLA contracts. The pod controller determines which container requires which resources and for how long in order to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, a pod controller may serve a security role that prevents assignment of resources until the right tenant authenticates or prevents provisioning of data or a workload to a container until an attestation result is satisfied.

Also, with the use of container pods, tenant boundaries can still exist but in the context of each pod of containers. If each tenant specific pod has a tenant specific pod controller, there will be a shared pod controller that consolidates resource allocation requests to avoid typical resource starvation situations. Further controls may be provided to ensure attestation and trustworthiness of the pod and pod controller. For instance, the orchestrator 460 may provision an attestation verification policy to local pod controllers that perform attestation verification. If an attestation satisfies a policy for a first tenant pod controller but not a second tenant pod controller, then the second pod could be migrated to a different edge node that does satisfy it. Alternatively, the first pod may be allowed to execute and a different shared pod controller is installed and invoked prior to the second pod executing.

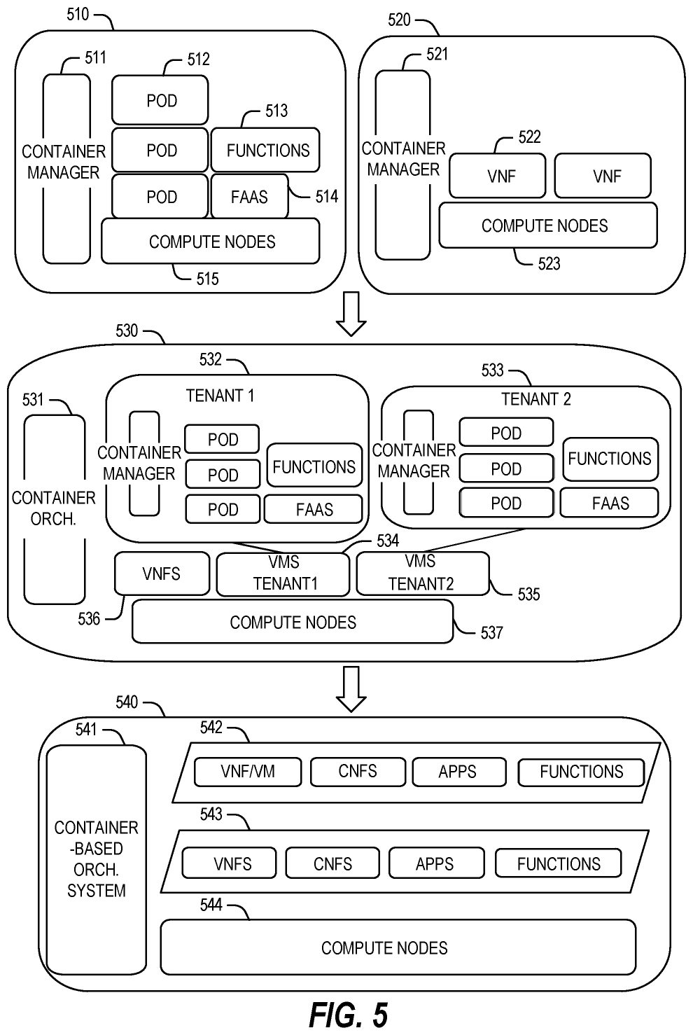

FIG. 5 illustrates additional compute arrangements deploying containers in an edge computing system. As a simplified example, system arrangements 510, 520 depict settings in which a pod controller (e.g., container managers 511, 521, and container orchestrator 531) is adapted to launch containerized pods, functions, and functions-as-a-service instances through execution via compute nodes (515 in arrangement 510), or to separately execute containerized virtualized network functions through execution via compute nodes (523 in arrangement 520). This arrangement is adapted for use of multiple tenants in system arrangement 530 (using compute nodes 537), where containerized pods (e.g., pods 512), functions (e.g., functions 513, VNFs 522, 536), and functions-as-a-service instances (e.g., FaaS instance 514) are launched within virtual machines (e.g., VMs 534, 535 for tenants 532, 533) specific to respective tenants (aside the execution of virtualized network functions). This arrangement is further adapted for use in system arrangement 540, which provides containers 542, 543, or execution of the various functions, applications, and functions on compute nodes 544, as coordinated by an container-based orchestration system 541.

The system arrangements of depicted in FIG. 5 provides an architecture that treats VMs, Containers, and Functions equally in terms of application composition (and resulting applications are combinations of these three ingredients). Each ingredient may involve use of one or more accelerator (FPGA, ASIC) components as a local backend. In this manner, applications can be split across multiple edge owners, coordinated by an orchestrator.

In the context of FIG. 5, the pod controller/container manager, container orchestrator, and individual nodes may provide a security enforcement point. However, tenant isolation may be orchestrated where the resources allocated to a tenant are distinct from resources allocated to a second tenant, but edge owners cooperate to ensure resource allocations are not shared across tenant boundaries. Or, resource allocations could be isolated across tenant boundaries, as tenants could allow “use” via a subscription or transaction/contract basis. In these contexts, virtualization, containerization, enclaves and hardware partitioning schemes may be used by edge owners to enforce tenancy. Other isolation environments may include: bare metal (dedicated) equipment, virtual machines, containers, virtual machines on containers, or combinations thereof.

In further examples, aspects of software-defined or controlled silicon hardware, and other configurable hardware, may integrate with the applications, functions, and services an edge computing system. Software defined silicon may be used to ensure the ability for some resource or hardware ingredient to fulfill a contract or service level agreement, based on the ingredient's ability to remediate a portion of itself or the workload (e.g., by an upgrade, reconfiguration, or provision of new features within the hardware configuration itself).

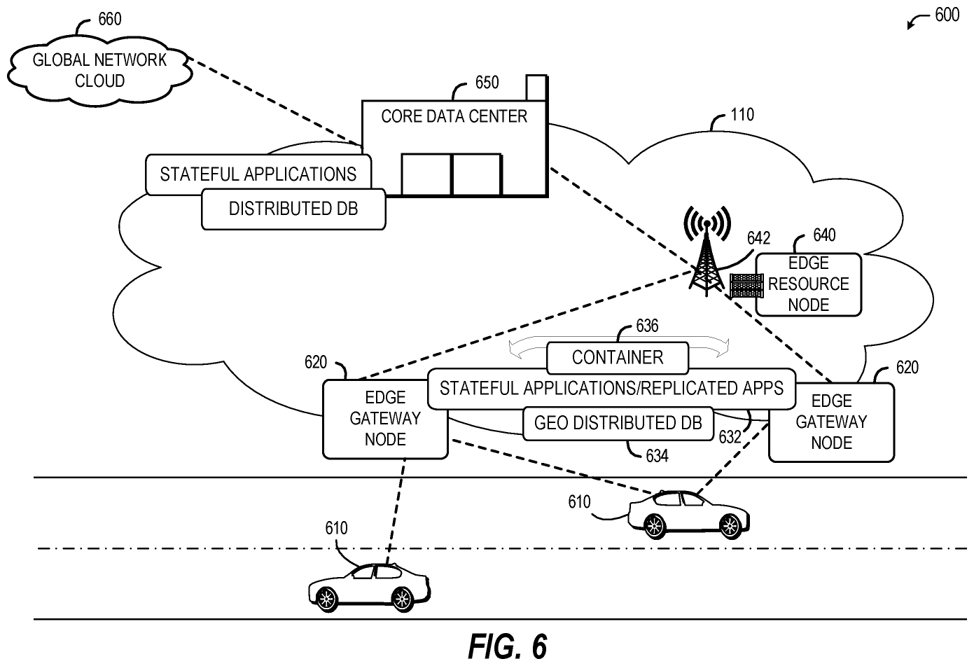

It should be appreciated that the edge computing systems and arrangements discussed herein may be applicable in various solutions, services, and/or use cases involving mobility. As an example, FIG. 6 shows a simplified vehicle compute and communication use case involving mobile access to applications in an edge computing system 600 that implements an edge cloud 110. In this use case, respective client compute nodes 610 may be embodied as in-vehicle compute systems (e.g., in-vehicle navigation and/or infotainment systems) located in corresponding vehicles which communicate with the edge gateway nodes 620 during traversal of a roadway. For instance, the edge gateway nodes 620 may be located in a roadside cabinet or other enclosure built-into a structure having other, separate, mechanical utility, which may be placed along the roadway, at intersections of the roadway, or other locations near the roadway. As respective vehicles traverse along the roadway, the connection between its client compute node 610 and a particular edge gateway device 620 may propagate so as to maintain a consistent connection and context for the client compute node 610. Likewise, mobile edge nodes may aggregate at the high priority services or according to the throughput or latency resolution requirements for the underlying service(s) (e.g., in the case of drones). The respective edge gateway devices 620 include an amount of processing and storage capabilities and, as such, some processing and/or storage of data for the client compute nodes 610 may be performed on one or more of the edge gateway devices 620.

The edge gateway devices 620 may communicate with one or more edge resource nodes 640, which are illustratively embodied as compute servers, appliances or components located at or in a communication base station 642 (e.g., a based station of a cellular network). As discussed above, the respective edge resource nodes 640 include an amount of processing and storage capabilities and, as such, some processing and/or storage of data for the client compute nodes 610 may be performed on the edge resource node 640. For example, the processing of data that is less urgent or important may be performed by the edge resource node 640, while the processing of data that is of a higher urgency or importance may be performed by the edge gateway devices 620 (depending on, for example, the capabilities of each component, or information in the request indicating urgency or importance). Based on data access, data location or latency, work may continue on edge resource nodes when the processing priorities change during the processing activity. Likewise, configurable systems or hardware resources themselves can be activated (e.g., through a local orchestrator) to provide additional resources to meet the new demand (e.g., adapt the compute resources to the workload data).

The edge resource node(s) 640 also communicate with the core data center 650, which may include compute servers, appliances, and/or other components located in a central location (e.g., a central office of a cellular communication network). The core data center 650 may provide a gateway to the global network cloud 660 (e.g., the Internet) for the edge cloud 110 operations formed by the edge resource node(s) 640 and the edge gateway devices 620. Additionally, in some examples, the core data center 650 may include an amount of processing and storage capabilities and, as such, some processing and/or storage of data for the client compute devices may be performed on the core data center 650 (e.g., processing of low urgency or importance, or high complexity).

The edge gateway nodes 620 or the edge resource nodes 640 may offer the use of stateful applications 632 and a geographic distributed database 634. Although the applications 632 and database 634 are illustrated as being horizontally distributed at a layer of the edge cloud 110, it will be understood that resources, services, or other components of the application may be vertically distributed throughout the edge cloud (including, part of the application executed at the client compute node 610, other parts at the edge gateway nodes 620 or the edge resource nodes 640, etc.). Additionally, as stated previously, there can be peer relationships at any level to meet service objectives and obligations. Further, the data for a specific client or application can move from edge to edge based on changing conditions (e.g., based on acceleration resource availability, following the car movement, etc.). For instance, based on the “rate of decay” of access, prediction can be made to identify the next owner to continue, or when the data or computational access will no longer be viable. These and other services may be utilized to complete the work that is needed to keep the transaction compliant and lossless.

In further scenarios, a container 636 (or pod of containers) may be flexibly migrated from an edge node 620 to other edge nodes (e.g., 620, 640, etc.) such that the container with an application and workload does not need to be reconstituted, re-compiled, re-interpreted in order for migration to work. However, in such settings, there may be some remedial or “swizzling” translation operations applied. For example, the physical hardware at node 640 may differ from edge gateway node 620 and therefore, the hardware abstraction layer (HAL) that makes up the bottom edge of the container will be re-mapped to the physical layer of the target edge node. This may involve some form of late-binding technique, such as binary translation of the HAL from the container native format to the physical hardware format, or may involve mapping interfaces and operations. A pod controller may be used to drive the interface mapping as part of the container lifecycle, which includes migration to/from different hardware environments.

The scenarios encompassed by FIG. 6 may utilize various types of mobile edge nodes, such as an edge node hosted in a vehicle (car/truck/tram/train) or other mobile unit, as the edge node will move to other geographic locations along the platform hosting it. With vehicle-to-vehicle communications, individual vehicles may even act as network edge nodes for other cars, (e.g., to perform caching, reporting, data aggregation, etc.). Thus, it will be understood that the application components provided in various edge nodes may be distributed in static or mobile settings, including coordination between some functions or operations at individual endpoint devices or the edge gateway nodes 620, some others at the edge resource node 640, and others in the core data center 650 or global network cloud 660.

In further configurations, the edge computing system may implement FaaS computing capabilities through the use of respective executable applications and functions. In an example, a developer writes function code (e.g., “computer code” herein) representing one or more computer functions, and the function code is uploaded to a FaaS platform provided by, for example, an edge node or data center. A trigger such as, for example, a service use case or an edge processing event, initiates the execution of the function code with the FaaS platform.

In an example of FaaS, a container is used to provide an environment in which function code (e.g., an application which may be provided by a third party) is executed. The container may be any isolated-execution entity such as a process, a Docker or Kubernetes container, a virtual machine, etc. Within the edge computing system, various datacenter, edge, and endpoint (including mobile) devices are used to “spin up” functions (e.g., activate and/or allocate function actions) that are scaled on demand. The function code gets executed on the physical infrastructure (e.g., edge computing node) device and underlying virtualized containers. Finally, container is “spun down” (e.g., deactivated and/or deallocated) on the infrastructure in response to the execution being completed.

Further aspects of FaaS may enable deployment of edge functions in a service fashion, including a support of respective functions that support edge computing as a service (Edge-as-a-Service or “EaaS”). Additional features of FaaS may include: a granular billing component that enables customers (e.g., computer code developers) to pay only when their code gets executed; common data storage to store data for reuse by one or more functions; orchestration and management among individual functions; function execution management, parallelism, and consolidation; management of container and function memory spaces; coordination of acceleration resources available for functions; and distribution of functions between containers (including “warm” containers, already deployed or operating, versus “cold” which require initialization, deployment, or configuration).

The edge computing system 600 can include or be in communication with an edge provisioning node. The edge provisioning node may distribute software such as the example computer readable instructions 782 of FIG. 7B, to various receiving parties for implementing any of the methods described herein. The example edge provisioning node 644 may be implemented by any computer server, home server, content delivery network, virtual server, software distribution system, central facility, storage device, storage node, data facility, cloud service, etc., capable of storing and/or transmitting software instructions (e.g., code, scripts, executable binaries, containers, packages, compressed files, and/or derivatives thereof) to other computing devices. Component(s) of the example edge provisioning node 644 may be located in a cloud, in a local area network, in an edge network, in a wide area network, on the Internet, and/or any other location communicatively coupled with the receiving party(ies). The receiving parties may be customers, clients, associates, users, etc. of the entity owning and/or operating the edge provisioning node 644. For example, the entity that owns and/or operates the edge provisioning node 644 may be a developer, a seller, and/or a licensor (or a customer and/or consumer thereof) of software instructions such as the example computer readable instructions 782 of FIG. 7B. The receiving parties may be consumers, service providers, users, retailers, OEMs, etc., who purchase and/or license the software instructions for use and/or re-sale and/or sub-licensing.

In an example, edge provisioning node 644 includes one or more servers and one or more storage devices. The storage devices host computer readable instructions such as the example computer readable instructions 782 of FIG. 7B, as described below. Similarly to edge gateway devices 620 described above, the one or more servers of the edge provisioning node 644 are in communication with a base station 642 or other network communication entity. In some examples, the one or more servers are responsive to requests to transmit the software instructions to a requesting party as part of a commercial transaction. Payment for the delivery, sale, and/or license of the software instructions may be handled by the one or more servers of the software distribution platform and/or via a third party payment entity. The servers enable purchasers and/or licensors to download the computer readable instructions 782 from the edge provisioning node 644. For example, the software instructions, which may correspond to the example computer readable instructions 782 of FIG. 7B, may be downloaded to the example processor platform/s, which is to execute the computer readable instructions 782 to implement the methods described herein.

In some examples, the processor platform(s) that execute the computer readable instructions 782 can be physically located in different geographic locations, legal jurisdictions, etc. In some examples, one or more servers of the edge provisioning node 644 periodically offer, transmit, and/or force updates to the software instructions (e.g., the example computer readable instructions 782 of FIG. 7B) to ensure improvements, patches, updates, etc. are distributed and applied to the software instructions implemented at the end user devices. In some examples, different components of the computer readable instructions 782 can be distributed from different sources and/or to different processor platforms; for example, different libraries, plug-ins, components, and other types of compute modules, whether compiled or interpreted, can be distributed from different sources and/or to different processor platforms. For example, a portion of the software instructions (e.g., a script that is not, in itself, executable) may be distributed from a first source while an interpreter (capable of executing the script) may be distributed from a second source.

In further examples, any of the compute nodes or devices discussed with reference to the present edge computing systems and environment may be fulfilled based on the components depicted in FIGS. 7A and 7B. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 7A, an edge compute node 700 includes a compute engine (also referred to herein as “compute circuitry”) 702, an input/output (I/O) subsystem 708, data storage 710, a communication circuitry subsystem 712, and, optionally, one or more peripheral devices 714. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 700 may be embodied as any type of engine, device, or collection of devices capable of performing various compute functions. In some examples, the compute node 700 may be embodied as a single device such as an integrated circuit, an embedded system, a field-programmable gate array (FPGA), a system-on-a-chip (SOC), or other integrated system or device. In the illustrative example, the compute node 700 includes or is embodied as a processor 704 and a memory 706. The processor 704 may be embodied as any type of processor capable of performing the functions described herein (e.g., executing an application). For example, the processor 704 may be embodied as a multi-core processor(s), a microcontroller, a processing unit, a specialized or special purpose processing unit, or other processor or processing/controlling circuit.

In some examples, the processor 704 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 704 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that a xPU, a SOC, a CPU, and other variations of the processor 704 may work in coordination with each other to execute many types of operations and instructions within and on behalf of the compute node 700.

The memory 706 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 706 may be integrated into the processor 704. The memory 706 may store various software and data used during operation such as one or more applications, data operated on by the application(s), libraries, and drivers.

The compute circuitry 702 is communicatively coupled to other components of the compute node 700 via the I/O subsystem 708, which may be embodied as circuitry and/or components to facilitate input/output operations with the compute circuitry 702 (e.g., with the processor 704 and/or the main memory 706) and other components of the compute circuitry 702. For example, the I/O subsystem 708 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 708 may form a portion of a system-on-a-chip (SoC) and be incorporated, along with one or more of the processor 704, the memory 706, and other components of the compute circuitry 702, into the compute circuitry 702.

The one or more illustrative data storage devices 710 may be embodied as any type of devices configured for short-term or long-term storage of data such as, for example, memory devices and circuits, memory cards, hard disk drives, solid-state drives, or other data storage devices. Individual data storage devices 710 may include a system partition that stores data and firmware code for the data storage device 710. Individual data storage devices 710 may also include one or more operating system partitions that store data files and executables for operating systems depending on, for example, the type of compute node 700.

The communication circuitry 712 may be embodied as any communication circuit, device, or collection thereof, capable of enabling communications over a network between the compute circuitry 702 and another compute device (e.g., an edge gateway of an implementing edge computing system). The communication circuitry 712 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 712 includes a network interface controller (NIC) 720, which may also be referred to as a host fabric interface (HFI). The NIC 720 may be embodied as one or more add-in-boards, daughter cards, network interface cards, controller chips, chipsets, or other devices that may be used by the compute node 700 to connect with another compute device (e.g., an edge gateway node). In some examples, the NIC 720 may be embodied as part of a system-on-a-chip (SoC) that includes one or more processors, or included on a multichip package that also contains one or more processors. In some examples, the NIC 720 may include a local processor (not shown) and/or a local memory (not shown) that are both local to the NIC 720. In such examples, the local processor of the NIC 720 may be capable of performing one or more of the functions of the compute circuitry 702 described herein. Additionally, or alternatively, in such examples, the local memory of the NIC 720 may be integrated into one or more components of the client compute node at the board level, socket level, chip level, and/or other levels.

Additionally, in some examples, a respective compute node 700 may include one or more peripheral devices 714. Such peripheral devices 714 may include any type of peripheral device found in a compute device or server such as audio input devices, a display, other input/output devices, interface devices, and/or other peripheral devices, depending on the particular type of the compute node 700. In further examples, the compute node 700 may be embodied by a respective edge compute node (whether a client, gateway, or aggregation node) in an edge computing system or like forms of appliances, computers, subsystems, circuitry, or other components.

In a more detailed example, FIG. 7B illustrates a block diagram of an example of components that may be present in an edge computing node 750 for implementing the techniques (e.g., operations, processes, methods, and methodologies) described herein. This edge computing node 750 provides a closer view of the respective components of node 700 when implemented as or as part of a computing device (e.g., as a mobile device, a base station, server, gateway, etc.). The edge computing node 750 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 750, or as components otherwise incorporated within a chassis of a larger system.

The edge computing device 750 may include processing circuitry in the form of a processor 752, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 752 may be a part of a system on a chip (SoC) in which the processor 752 and other components are formed into a single integrated circuit, or a single package, such as the Edison™ or Galileo™ SoC boards from Intel Corporation, Santa Clara, California. As an example, the processor 752 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, California, a MIPS®-based design from MIPS Technologies, Inc. of Sunnyvale, California, an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 752 and accompanying circuitry may be provided in a single socket form factor, multiple socket form factor, or a variety of other formats, including in limited hardware configurations or configurations that include fewer than all elements shown in FIG. 7B.

The processor 752 may communicate with a system memory 754 over an interconnect 756 (e.g., a bus). Any number of memory devices may be used to provide for a given amount of system memory. As examples, the memory 754 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDlMMs or MiniDIMMs.

To provide for persistent storage of information such as data, applications, operating systems and so forth, a storage 758 may also couple to the processor 752 via the interconnect 756. In an example, the storage 758 may be implemented via a solid-state disk drive (SSDD). Other devices that may be used for the storage 758 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 758 may be on-die memory or registers associated with the processor 752. However, in some examples, the storage 758 may be implemented using a micro hard disk drive (HDD). Further, any number of new technologies may be used for the storage 758 in addition to, or instead of, the technologies described, such resistance change memories, phase change memories, holographic memories, or chemical memories, among others.

The components may communicate over the interconnect 756. The interconnect 756 may include any number of technologies, including industry standard architecture (ISA), extended ISA (EISA), peripheral component interconnect (PCI), peripheral component interconnect extended (PCIx), PCI express (PCIe), or any number of other technologies. The interconnect 756 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 756 may couple the processor 752 to a transceiver 766, for communications with the connected edge devices 762. The transceiver 766 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 762. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 766 (or multiple transceivers) may communicate using multiple standards or radios for communications at a different range. For example, the edge computing node 750 may communicate with close devices, e.g., within about 10 meters, using a local transceiver based on Bluetooth Low Energy (BLE), or another low power radio, to save power. More distant connected edge devices 762, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 766 (e.g., a radio transceiver) may be included to communicate with devices or services in the edge cloud 795 via local or wide area network protocols. The wireless network transceiver 766 may be a low-power wide-area (LPWA) transceiver that follows the IEEE 802.15.4, or IEEE 802.15.4g standards, among others. The edge computing node 750 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 766, as described herein. For example, the transceiver 766 may include a cellular transceiver that uses spread spectrum (SPA/SAS) communications for implementing high-speed communications. Further, any number of other protocols may be used, such as Wi-Fi® networks for medium speed communications and provision of network communications. The transceiver 766 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 768 may be included to provide a wired communication to nodes of the edge cloud 795 or to other devices, such as the connected edge devices 762 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 768 may be included to enable connecting to a second network, for example, a first NIC 768 providing communications to the cloud over Ethernet, and a second NIC 768 providing communications to other devices over another type of network.

Given the variety of types of applicable communications from the device to another component or network, applicable communications circuitry used by the device may include or be embodied by any one or more of components 764, 766, 768, or 770. Accordingly, in various examples, applicable means for communicating (e.g., receiving, transmitting, etc.) may be embodied by such communications circuitry.

The edge computing node 750 may include or be coupled to acceleration circuitry 764, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 756 may couple the processor 752 to a sensor hub or external interface 770 that is used to connect additional devices or subsystems. The devices may include sensors 772, such as accelerometers, level sensors, flow sensors, optical light sensors, camera sensors, temperature sensors, global navigation system (e.g., GPS) sensors, pressure sensors, barometric pressure sensors, and the like. The hub or interface 770 further may be used to connect the edge computing node 750 to actuators 774, such as power switches, valve actuators, an audible sound generator, a visual warning device, and the like.

In some optional examples, various input/output (I/O) devices may be present within or connected to, the edge computing node 750. For example, a display or other output device 784 may be included to show information, such as sensor readings or actuator position. An input device 786, such as a touch screen or keypad may be included to accept input. An output device 784 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 750. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 776 may power the edge computing node 750, although, in examples in which the edge computing node 750 is mounted in a fixed location, it may have a power supply coupled to an electrical grid, or the battery may be used as a backup or for temporary capabilities. The battery 776 may be a lithium ion battery, or a metal-air battery, such as a zinc-air battery, an aluminum-air battery, a lithium-air battery, and the like.

A battery monitor/charger 778 may be included in the edge computing node 750 to track the state of charge (SoCh) of the battery 776, if included. The battery monitor/charger 778 may be used to monitor other parameters of the battery 776 to provide failure predictions, such as the state of health (SoH) and the state of function (SoF) of the battery 776. The battery monitor/charger 778 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 778 may communicate the information on the battery 776 to the processor 752 over the interconnect 756. The battery monitor/charger 778 may also include an analog-to-digital (ADC) converter that enables the processor 752 to directly monitor the voltage of the battery 776 or the current flow from the battery 776. The battery parameters may be used to determine actions that the edge computing node 750 may perform, such as transmission frequency, mesh network operation, sensing frequency, and the like.

A power block 780, or other power supply coupled to a grid, may be coupled with the battery monitor/charger 778 to charge the battery 776. In some examples, the power block 780 may be replaced with a wireless power receiver to obtain the power wirelessly, for example, through a loop antenna in the edge computing node 750. A wireless battery charging circuit, such as an LTC4020 chip from Linear Technologies of Milpitas, California, among others, may be included in the battery monitor/charger 778. The specific charging circuits may be selected based on the size of the battery 776, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 758 may include instructions 782 in the form of software, firmware, or hardware commands to implement the techniques described herein. Although such instructions 782 are shown as code blocks included in the memory 754 and the storage 758, it may be understood that any of the code blocks may be replaced with hardwired circuits, for example, built into an application specific integrated circuit (ASIC).

In an example, the instructions 782 provided via the memory 754, the storage 758, or the processor 752 may be embodied as a non-transitory, machine-readable medium 760 including code to direct the processor 752 to perform electronic operations in the edge computing node 750. The processor 752 may access the non-transitory, machine-readable medium 760 over the interconnect 756. For instance, the non-transitory, machine-readable medium 760 may be embodied by devices described for the storage 758 or may include specific storage units such as optical disks, flash drives, or any number of other hardware devices. The non-transitory, machine-readable medium 760 may include instructions to direct the processor 752 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 782 on the processor 752 (separately, or in combination with the instructions 782 of the machine readable medium 760) may configure execution or operation of a trusted execution environment (TEE) 790. In an example, the TEE 790 operates as a protected area accessible to the processor 752 for secure execution of instructions and secure access to data. Various implementations of the TEE 790, and an accompanying secure area in the processor 752 or the memory 754 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 750 through the TEE 790 and the processor 752.

In further examples, a machine-readable medium also includes any tangible medium that is capable of storing, encoding, or carrying instructions for execution by a machine and that cause the machine to perform any one or more of the methodologies of the present disclosure or that is capable of storing, encoding, or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., Hypertext Transfer Protocol (HTTP)).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

As discussed above, edge computing involves many scenarios where computing is performed at the edge, such as closer to users such as base stations/cell towers and central offices. An edge system may act based on predictions (e.g., estimates) or changes to power availability, workload constraints, scheduling, etc.

Edge devices operate in a resource constrained environment, and may include only edge servers deployed at various locations, for example with a single server per location along a route. This server performs critical edge activities, by offering services closer to edge devices, with the ultra-low latencies that may be required of the edge environment. These type of deployments, often in street cabinets, are also called roadside units (RSUs).

Edge servers may be equipped with power-efficient processors, such as an Infrastructure Processing Unit (IPU) for various specialized processing. IPUs (which may also be referred to or substituted for a smart NIC, an EPU, etc.) may augment compute capability of a platform (e.g., a CPU), such as by operating as a offload vehicle.

One issue in edge deployments with remote locations is the need to reboot a server to apply maintenance patches, security upgrades, or the like. The downtime of the edge service may cause service issues. When there is more than one server at an edge location, downtime for the servers may be handled by a coordinated round robin upgrade cycle. In remote locations, having more than one server may not be practical or efficient. In some cases, a nearby edge server in a different location may be used to continue a service, however latencies may become high or intermittent loss of network connectivity between the edge server and the base station may occur. In cases when there is a single server deployment, rebooting the RSU currently causes downtime for the edge service being hosted on the processors.

The systems and techniques described herein address these technical problems with unique architectural constructs that enable continuity of service for remote servers by seamless handoff between the CPU and IPU in the platform. For example, security patches or upgrade patches may be pushed onto the RSU at times when there is network connectivity, and the patch may be applied at scheduled times independent of connectivity, with zero downtime. The IPU may take over edge service during the reboot, remaining “on” using independent power to continue processing service queries while the CPU reboots to apply a patch. The IPU may return control to the CPU when the CPU is back up. To offset a potential reduced SLA capability due to IPU having less compute resources than the CPU, the systems and techniques described herein leverage accelerators or decoupled cores to mitigate the issue. A related issue occurs when a user wants to perform a remote reboot, for example via baseboard management controller (BMC), there is forced interruption of service. In such cases, the BMC may check that the IPU has taken over service handling from the CPU, before making the CPU reboot. In some examples, an update to the CPU may include a change to BIOS, a change to firmware, a microcode patch, or the like. In some examples, a CPU may be identified as running malicious or potentially malicious software. In these examples, the CPU may be rebooted into a previous state, updated to a safe state, etc. Before the reboot, the IPU may be used to back up some portion of CPU processing (e.g., excluding the malicious or potentially malicious processing).

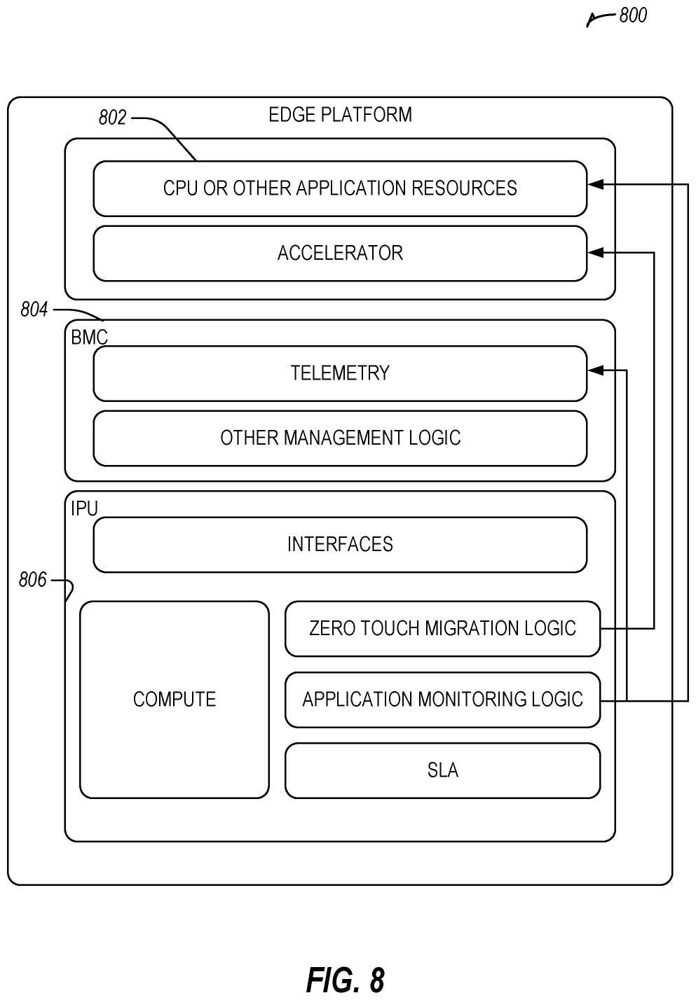

FIG. 8 illustrates an example edge platform 800 in accordance with some embodiments. The edge platform 800 includes a CPU 802, BMC 804, and IPU 806. The IPU 806 includes monitoring logic that may be used to identify when the CPU 802 or other portion of the edge platform 800 hangs or when there is a likelihood the CPU 802 will be rebooted (e.g., a crash, OS unresponsive, etc.). The monitoring logic may monitor an operating system and coordinate with the BMC 804 to identify when an event is about to happen to trigger a zero down time migration.

The IPU 806 includes zero-touch migration logic that is used to migrate an application (e.g., a critical application running on the CPU 802) to the IPU 806. Migration may occur fully (e.g., where compute and memory data are copied) or may occur partially (e.g., where only compute is migrated). In the partial example, when the OS or platform supports partial migration, only compute may be migrated. In this example, data (e.g., memory or disk) may be kept and not removed on reboot.

The BMC 804 may include management logic to pause a remote reboot. For example, when a remote reboot is ordered to the edge platform 800, the BMC 804 may notify the IPU 806 of the reboot using the management logic. The BMC 804 may check that the IPU 806 is configured to perform the zero down-time migration and then initiate a reboot (e.g., of the CPU 802 and optionally other components, excepting the IPU 806, for example).

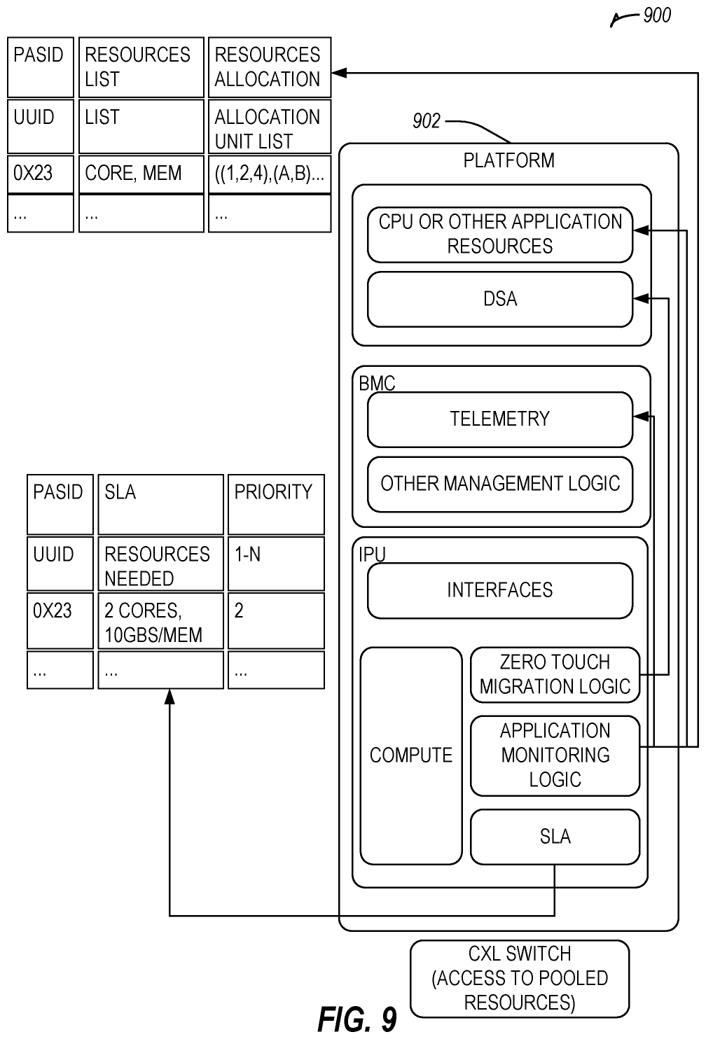

FIG. 9 illustrates an example architecture 900 for an edge platform in accordance with some embodiments. The example architecture 900 may be used with the edge platform 800 of FIG. 8. For example, the example architecture 900 includes a platform 902, which may be the edge platform 800 of FIG. 8. In an example, the example architecture 900 may include a state of discrete resource such as a GPU or other accelerator.

The example architecture 900 illustrates architectural building blocks that may be used to facilitate transferring processing from the CPU to the IPU. The CPU may use an accelerator, such as a data streaming accelerator (DSA) to move data from different places of the platform such as CPU to IPU, memory to memory, etc. The accelerator may use an interface to facilitates data movement from the CPU to the IPU when migration happens. The data movement may include identification of a source resource, a source data range (e.g., memory range), a target resource in the IPU, a target address, or the like.

The CPU may provide a register for monitoring (e.g., a control register such as a model-specific register (MSR)) for an OS or an application. An application or OS may use the register as a heartbeat to indicate that they are alive. In an example, the OS may use one register to indicate to the IPU that it will reboot in the next M milliseconds or seconds. This indication may trigger migration on the IPU side. The OS may delegate the migration to the IPU in some examples. The register may be managed through ring zero functions to prevent attacks and scalations.

The IPU may include building blocks that allow implementing a transfer from the CPU. For example, the IPU includes one or more interfaces that may be accessed out of order or in-band from the OS. The one or more interfaces may be authenticated. An example interface may include an interface to register applications or services with zero downtime requirements. The registration of an application or service may include an address space identifier (e.g., a process address space ID (PASID)) of the application or service, a priority of the application, or a list of resources that are part of the application or service. For each resource, information may be registered, such as a resource ID, where the resource is located (e.g. CPU, memory, device, etc.), a range of resources that are to be migrated, whether the resource range is to be moved or not, or the like. When the resource range is memory accessible via a memory coherent switch, migration may not be avoided (e.g., not required). Another example interface may provide SLA requirements for an application. Information related to SLA requirements may include resource type or ID (e.g., CORE, memory, etc.) or an amount (e.g., 4 cores, 10 GBS of memory, etc.). In some examples, a service level objective (SLO) may be used in place of or with an SLA requirement.

The IPU may include logic that is responsible for monitoring a status of the platform 902. The monitoring logic may access to the register discussed above. In an example, the monitoring logic may access and work with the BMC to identify potential hangs or reboots that are about to happen. The monitoring logic may trigger a data migration on detection of hang or reboot. When the BMC notifies a reboot, the monitoring logic may respond back to the BMC once the services have been migrated.

The IPU may include migration logic that is responsible to perform the migration. The migration logic may acknowledge start of migration to the BMC (or notify the BMC). The migration logic may start migrating services based on priority. For example, the migration logic may identify what resources are to be migrated, determine whether there are enough local resources available (e.g., determine capacity), and migrate a resource. When not enough resources are available, the IPU may indicate that the application cannot be migrated (e.g., when there is not enough space to copy state data), or the application may be migrated and downscaled. After the migration is complete, the IPU may notify the BMC.

The BMC may be used to intercept remote reboots and work with the IPU to determine whether to migrate a service or application. When migration is possible, the BMC may receive an indication from the IPU. The BMC may reboot the platform 902 (e.g., the CPU), and monitor the platform 902.

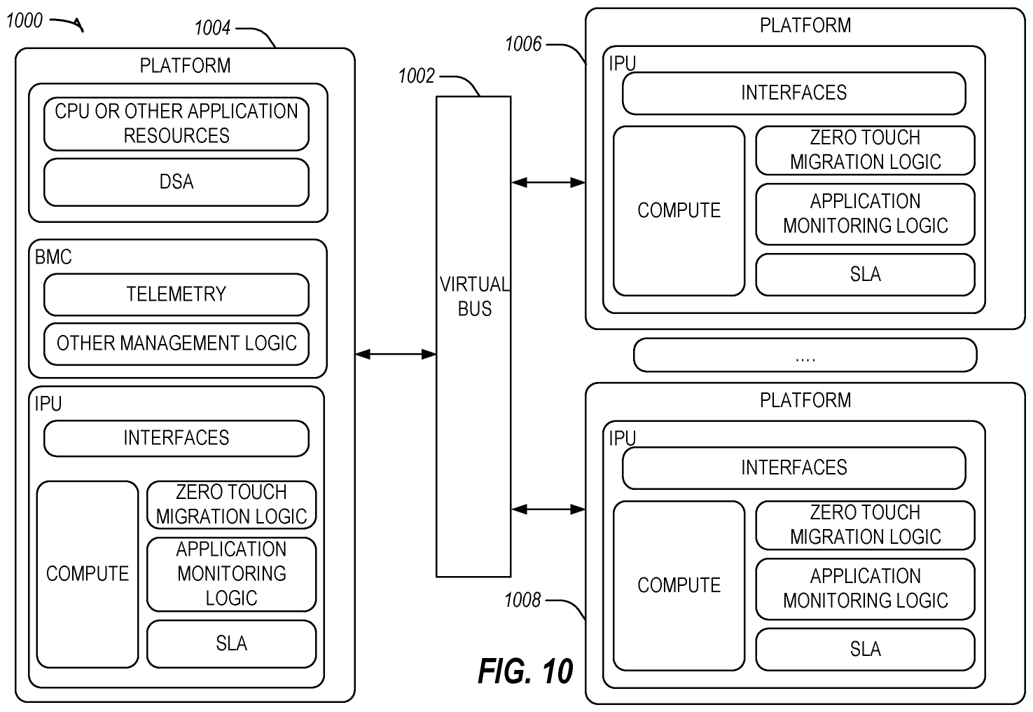

FIG. 10 illustrates an example system 1000 with a virtual bus 1002 for edge platform communication in accordance with some embodiments. The virtual bus 1002 may connect two or more platforms, such as platform 1004, 1006, or 1008. The virtual bus 1002 may be used for trusted multi-IPU monitoring, discovery, failover, or migration. As discussed above the systems and techniques described herein may be used for migrating a service or application from a CPU to an IPU of a single edge platform. These systems and techniques may be used in some examples to migrate a service or application from a first edge platform to a second edge platform, such as using an IPU of the first edge platform to perform the migration and a CPU of the second edge platform for execution of the service or application.

An IPU of a platform, for example platform 1004, may monitor local critical services of the platform 1004. The IPU may access, store, or otherwise include a heat map that may be constructed with other IPUs (e.g., nearby peers) that are part of trusted edge platforms. The heat map may provide an indication of which peers are available or capable of taking over particular services. For example, the IPU of the platform 1004 may have a heat map of services that may be performed by the platform 1006 or the platform 1008. The IPU may, on failure of its CPU or other platform component, use the heat map to determine a list of peers for moving the critical service. The heat map may be indexed, stored, or searched using a signature (e.g., used resources) of a critical service.

The IPU of platform 1004 may send a request to another IPU or may multicast a request or requests to peer IPUs (e.g., of platforms 1006 or 1008). When the request is accepted by a peer IPU, the IPU of platform 1004 may select one of the accepting peer IPUs to receive the migration, for example based on a first acceptance received, a lowest workload at accepting peers, a closest peer, etc.

The IPU of platform 1004 may coordinate with a remote IPU (e.g., of platform 1006 or 1008) and acceleration schemes to migrate the service. Migration may include using a memory coherency mechanism to access the state (e.g., memory, cache, storage, etc.) of the service to migrate via the peer IPU using same or similar constructs.

In an example, the set of IPUs belonging to a group of peer platforms (e.g., 1004, 1006, and 1008) may include a hive of edge servers that work together to implement low latency failover migration. In some examples, the peer group may include a universal map for the hive. In other examples, each IPU may generate its own heat map. An IPU may receive telemetry from peer platforms to keep the heat map up to date for rapid migration. In some examples, memory mirroring mechanisms may be implemented across edge locations with multiple edges via the distributed IPUs. Once a failure is detected, the various IPUs may work together to implement a mirror of the service and re-start where selected.

The IPUs cooperate when a service is being migrated in order to use local acceleration schemes (e.g., DSA) to move the service and status of the service, for example using memory protocols (e.g., via a Compute Express Link (CXL)). CXL may be used locally to access to service origin status (even after the node has crashed) moved over network to the target IPU and re-store the service.

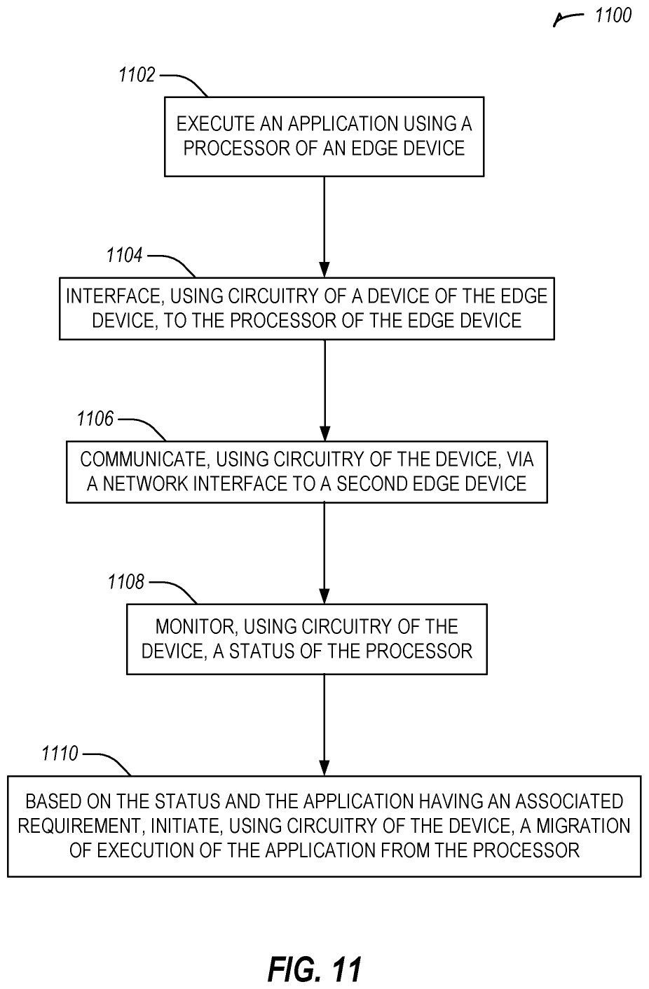

FIG. 11 illustrates a flowchart showing a technique 1100 for edge resource management in accordance with some embodiments. The technique 1100 may be performed by an edge device, such as using memory to store instructions for execution by circuitry. The edge device may be part of a system or hive (e.g., a group of edge devices in a particular area, within a particular distance or communication distance of each other, a designated group of devices, such as by an orchestrator, or the like).

The technique 1100 includes an operation 1102 to execute an application using a processor of an edge device. The technique 1100 includes an operation 1104 to interface, using circuitry of a device of the edge device, to the processor of the edge device. Operation 1104 may include obtaining a list of resources corresponding to the application. In some examples, the processor is a CPU and the device is an IPU. In an example, the device is a second general purpose processor. In other embodiments, the device may an FPGA, an ASIC, or other programmable hardware.

The technique 1100 includes an operation 1106 to communicate, using circuitry of the device, via a network interface to a second edge device. The technique 1100 includes an operation 1108 to monitor, using circuitry of the device, a status of the processor. The status may include a scheduled downtime for the processor to perform an update. The status may include an unscheduled downtime for the processor due to a power failure.

The technique 1100 includes an operation 1110 to, based on the status and the application having an associated requirement, initiate, using circuitry of the device, a migration of execution of the application from the processor. Operation 1110 may include sending an indication to an orchestrator. In some examples, the migration is to a second processor outside the edge device at a second edge device. The second edge device may be located within a communication threshold range. In other examples, the migration is to a second processor outside the edge device at a cloud server. In still other examples, the migration is to the circuitry of the device. The associated requirement of the application may include a zero downtime requirement of the application. In an example, the edge device communicates, orchestrates, multicasts, or negotiates migration of at least one of processor or memory services from the edge device to the second edge device.

The technique 1100 may include an operation to use a battery to power an event recorder device, and store, at the event recorder device, telemetry data captured by at least one sensor of the edge device. The event recorder device may be activated when the edge device loses power. The at least one sensor may include at least one of a thermal sensor, a movement sensor, a pin in a device connector, an electric charge detector, a pressure sensor, or the like.

In an example, the edge device may include a baseboard management controller (BMC). The technique 1100 may include using the BMC to intercept a remote reboot command directed at the processor and send the status of the processor to the device before the processor reboots.

In an example, when a system needs to be shut down or a predicted power off is determined based on current battery or thermals, the technique 110 may be used to migrate services that are running locally into another edge node. For example, an estimation model (such as LSTM) may be used to predict whether the system will be powered off based on current circumstances (e.g. battery charge). When there is a likelihood (e.g., above a threshold) that the system will be powered off in a near time frame (e.g., next few seconds or minutes), migration circuitry may be executed to migrate the local services into a peer, such as a peer that is pre-established or group of peers. The system may be powered off and the MTU may be triggered after migration.

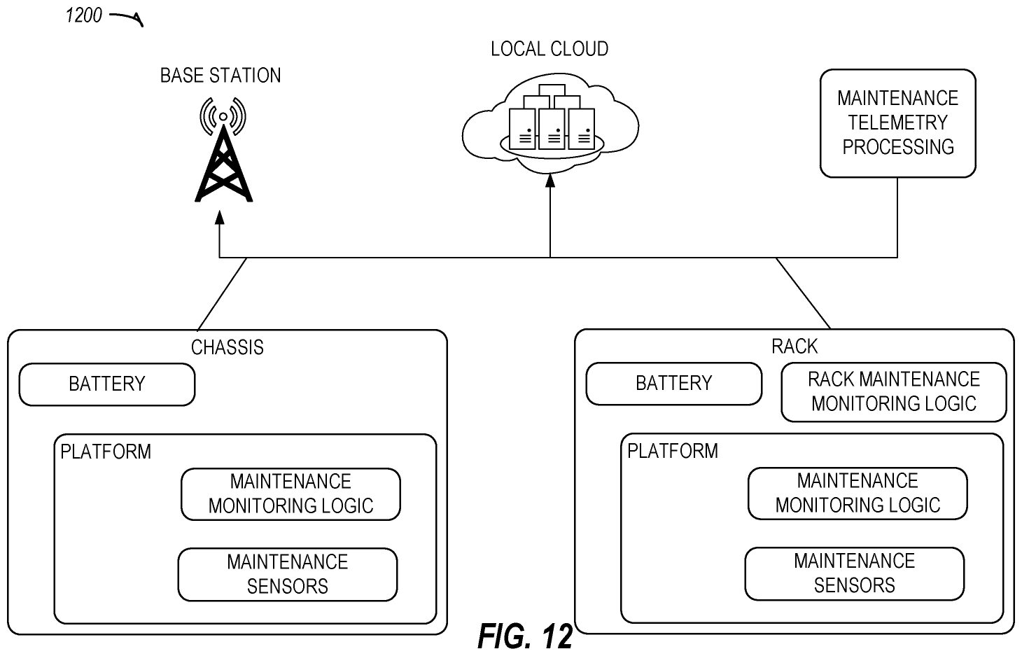

FIG. 12 illustrates an example architecture 1200 for a maintenance telemetry monitoring unit in accordance with some embodiments. The architecture 1200 may be used with an edge platform that is in a difficult to access location, a location that is not temperature-controlled, a location subject to variations in temperature, or the like. This may lead to higher failure rates. Edge servers are often subject to more movement relative to cloud data centers, for example due to the location of the edge server (e.g., on a balloon, a robot, a truck, etc.) or because of ambient surroundings. Edge servers are more likely to be subject to errors and require more maintenance due to factors such as greater temperature variations, movement, etc. When an error occurs, it is far more difficult to perform maintenance on an edge server compared to a conventional server in a data center.

This places sharp emphasis on efficiencies during the maintenance process. Unfortunately, in current system deployments, what happens during server maintenance is often a unknown after a power supply is disconnected. The systems and techniques described herein provide insight into the system state at time of failure, before the failure, or after the failure. For example, information may include how much the server was moved, what kind of temperature variations occurred during maintenance, in what order different components were removed or replaced, etc.

The systems and techniques described herein addresses the problem of lack of observability once power supply is disconnected during maintenance for edge servers. A set of platform sensors may be used to provide telemetry on an independent power domain, for example backed by one or more batteries. The sensors may provide telemetry related to thermals, movement, device connectivity (PCI-E devices etc. being unplugged and plugged), or the like during maintenance or unforeseen downtimes. This data may be used for traceability analysis for error debugs. Cross-location and longer duration observability may be used for analytics-driven efficiencies in how edge server maintenance is performed.

A system, such as a platform, chassis, or rack (e.g., depending on the deployment model) may include a battery (e.g., a custom battery) that powers one or more sensors of the system and architecture to be collected during a maintenance task or other downtime. The sensors and monitoring logic may be powered by the battery. In some examples, the sensors may be activated during maintenance or triggered when there is no power. The sensors collect that collect data may include a thermal sensor, such as in different parts of the system, a movement sensor (e.g., an accelerometer) in the system, a pin in the device connector (e.g. in the Peripheral Component Interconnect Express (PCIE) bus) to identify that a given device is unplugged or plugged in, or the like.

The platform, chassis, or rack may include maintenance telemetry logic that is responsible for collecting telemetry when a maintenance operation is performed or when a power outage occurs. The telemetry may be stored in persistent media and may be accessed offline or at a later time, such as with proper authentication. After performance of a telemetry storage operation, the telemetry operation may be processed locally by the platform or stored. When processed locally, logic that applies machine learning may be used to identify potential problems. In other examples, data may be processed at a larger scale in the cloud.

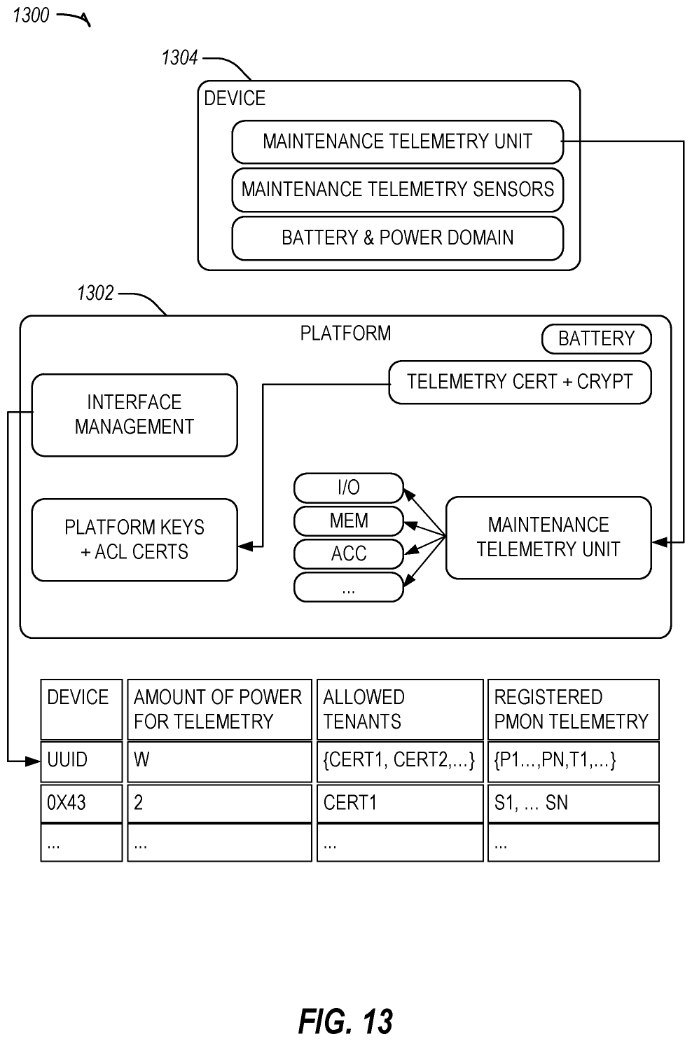

FIG. 13 illustrates an example architecture 1300 for a maintenance telemetry monitoring unit in accordance with some embodiments. The architecture 1300 may include logic that determines how much power is provided to various components of the system, such as when there is a problem with energy availability. Different configurations may be specified (e.g., by an operator), such as priority of sensors, sampling rate per sensor, identification of sensors that need to be collected, sensors that do not need energy, etc.

The battery and power domain may be defined in a hierarchical way. For example, a rack level, then a chassis level, then a platform level, then a device level. The deployment of battery placement and energy flow may occur in different places within the system.

Each of the elements of the system architecture (e.g., platform, chassis, devices, etc.) may include a set of sensors that are activated during maintenance or when there is no power. Example sensors include thermal sensors in different parts of the platform, movement sensors in a platform 1302 and devices, pin in the device connectors (e.g., in the PCIE bus) to identify that a given device (e.g., device 1304) is unplugged or plugged in, an electric charge that may be identified at a particular point of time, an amount of pressure in a device (e.g., to identify how much weight was put on the device or platform 1302 itself), or the like. The platform 1302 may include an event recorder device.

The devices may include sensors that operate for few seconds, minutes, or hours even after the device is removed from the chassis and power domain. This may be facilitated with a battery in the device that collects telemetry during a certain period of time. For example, the collected telemetry may be used to identify what happened on a device that is moved from one PCIe slot to another one. When a new device is connected into the platform 1302 again (or to the maintenance power domain), the maintenance telemetry unit (MTU) on the platform 1302 may identify the device to allow mapping on the sensor data with the device itself.

The platform 1302 or chassis may include the MTU that is responsible to collect the telemetry when a maintenance operation is performed or when on power outage. MTU logic may be placed at one or more places (e.g., the platform 1302, the chassis, the device 1304, etc.). Each MTU may act in a hierarchical way. For example, an MTU of the device 1304 may provide sensor data to the MTU at the platform 1302. The MTU at the platform 1302 may provide sensor data to an MTU at chassis level (if used). The optional MTU at chassis level may provide sensor data to the MTU at rack level (if used).

Telemetry may be stored in persistent media that can be accessed post maintenance. The persistent memory may be stored on the platform 1302, or the device 1304. When a power outage or maintenance operation occurs, logic may be used to activate one or more sensors, such as based on a configuration provided by the operator. The logic may provide the configuration on how frequent data is to be updated in each of the sensors. Sensor collection may occur, such as actively by consulting the value at each sample of time, or via callback from the sensor at a time when a change is to be reported.

The system may use one or more interfaces to perform out of band access to the maintenance telemetry data after maintenance period. The may require authentication. In an example, the platform 1302 provides a different level of access to the data depending on how the data is accessed. For example, directly at the platform 1302, more data may be accessible than via a remote access, or different levels of authentication may be used. In some examples, the different levels of access may be dependent on configuration of sensors of MTU, priority of sensors, sampling rate that is required per each of the sensors, sensors that are to be collected, sensors without energy use, or the like.

It should be understood that the functional units or capabilities described in this specification may have been referred to or labeled as components or modules, in order to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together but may comprise disparate instructions stored in different locations which, when joined logically together (e.g., including over a wire, over a network, using one or more platforms, wirelessly, via a software component, or the like), comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center) than that in which the code is deployed (e.g., in a computer embedded in a sensor or robot). Similarly, operational data may be identified and illustrated herein within components or modules and may be embodied in any suitable form and organized within any suitable type of data structure. The operational data may be collected as a single data set or may be distributed over different locations including over different storage devices, and may exist, at least partially, merely as electronic signals on a system or network. The components or modules may be passive or active, including agents operable to perform desired functions.

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

Each of these non-limiting examples may stand on its own, or may be combined in various permutations or combinations with one or more of the other examples.

Example 1 is an edge device comprising: a processor to execute an application; and a device including: an interface to the processor; a network interface; and circuitry to: monitor a status of the processor; and based on the status and the application having an associated objective, initiate a migration of execution of the application from the processor.

In Example 2, the subject matter of Example 1 includes, wherein to initiate the migration, the circuitry is to send an indication to an orchestrator.

In Example 3, the subject matter of Examples 1-2 includes, wherein the migration is to a second processor outside the edge device at a second edge device, the second edge device located within a communication threshold range.

In Example 4, the subject matter of Examples 1-3 includes, wherein the migration is to a second processor outside the edge device at a cloud server.

In Example 5, the subject matter of Examples 1-4 includes, wherein the migration is to the circuitry of the device.

In Example 6, the subject matter of Examples 1-5 includes, wherein the interface to the processor includes a list of resources corresponding to the application.

In Example 7, the subject matter of Examples 1-6 includes, wherein the status includes a scheduled downtime for the processor to perform an update.

In Example 8, the subject matter of Examples 1-7 includes, wherein the status includes an unscheduled downtime for the processor due to a power failure.

In Example 9, the subject matter of Examples 1-8 includes, wherein the processor is a central processing unit (CPU) and the device is one of an infrastructure processing unit (IPU), a data processing unit (DPU), or an edge processing unit (EPU).

In Example 10, the subject matter of Examples 1-9 includes, wherein the edge device includes an event recorder device, the event recorder device including: a battery to power the event recorder device; and memory to store telemetry data captured by at least one sensor of the edge device.

In Example 11, the subject matter of Example 10 includes, wherein the event recorder device is activated when the edge device loses power.

In Example 12, the subject matter of Examples 10-11 includes, wherein the at least one sensor includes at least one of a thermal sensor, a movement sensor, a pin in a device connector, an electric charge detector, or a pressure sensor.

In Example 13, the subject matter of Examples 1-12 includes, wherein the edge device includes a baseboard management controller (BMC) to: intercept a remote reboot command directed at the processor; and send the status of the processor to the device before the processor reboots.

In Example 14, the subject matter of Examples 1-13 includes, wherein the associated objective of the application includes a zero downtime requirement of the application.

Example 15 is at least one machine-readable medium, including instructions, which when executed by circuitry of a device of an edge device, cause the circuitry to perform operations to: interface to a processor of the edge device executing an application; communicate via a network interface to a second edge device; monitor a status of the processor; and based on the status and the application having an associated objective, initiate a migration of execution of the application from the processor.

In Example 16, the subject matter of Example 15 includes, wherein the edge device includes an event recorder device, the event recorder device including: a battery to power the event recorder device; and memory to store telemetry data captured by at least one sensor of the edge device.

In Example 17, the subject matter of Examples 15-16 includes, wherein the associated objective of the application includes a zero downtime requirement of the application.

In Example 18, the subject matter of Examples 15-17 includes, wherein the processor is a central processing unit (CPU) and the device is one of an infrastructure processing unit (IPU), a data processing unit (DPU), or an edge processing unit (EPU).

Example 19 is a method comprising: executing an application using a processor of an edge device; interfacing, using circuitry of a device of the edge device, to the processor of the edge device; communicating, using circuitry of the device, via a network interface to a second edge device; monitoring, using circuitry of the device, a status of the processor; and based on the status and the application having an associated objective, initiating, using circuitry of the device, a migration of execution of the application from the processor.

In Example 20, the subject matter of Example 19 includes, wherein initiating the migration includes executing the application at the circuitry of the device.

Example 21 is an edge device comprising: a first processor; and a second processor including: an interface to register an application, executing using the first processor, that has a zero downtime requirement; circuitry to: monitor a status of the first processor; and in response to the status of the first processor being indicative of a failure to comply with the zero downtime requirement of the application, initiate a migration of at least one resource from the first processor to a third processor to execute the application according to the zero downtime requirement.

In Example 22, the subject matter of Example 21 includes, wherein to initiate the migration, the circuitry is to send an indication to an orchestrator.

In Example 23, the subject matter of Examples 21-22 includes, wherein the third processor is outside the edge device at a second edge device, the second edge device located within a communication threshold range.

In Example 24, the subject matter of Examples 21-23 includes, wherein the third processor is outside the edge device at a cloud server.

In Example 25, the subject matter of Examples 21-24 includes, wherein the third processor is the second processor.

In Example 26, the subject matter of Examples 21-25 includes, wherein the interface includes a list of resources corresponding to the application, including the at least one resource.

In Example 27, the subject matter of Examples 21-26 includes, wherein the status includes a scheduled downtime for the first processor to perform an update.

In Example 28, the subject matter of Examples 21-27 includes, wherein the status includes an unscheduled downtime for the first processor due to a power failure.

In Example 29, the subject matter of Examples 21-28 includes, wherein the first processor is a central processing unit (CPU) and the second processor is an infrastructure processing unit (IPU).

In Example 30, the subject matter of Examples 21-29 includes, wherein the edge device includes an event recorder device, the event recorder device including: a battery to power the event recorder device; and memory to store telemetry data captured by at least one sensor of the edge device.

In Example 31, the subject matter of Example 30 includes, wherein the event recorder device is initiated when the edge device loses power.

In Example 32, the subject matter of Examples 30-31 includes, wherein the at least one sensor includes at least one of a thermal sensor, a movement sensor, a pin in a device connector, an electric charge detector, or a pressure sensor.

In Example 33, the subject matter of Examples 21-32 includes, wherein the edge device includes a baseboard management controller (BMC) to: intercept a remote reboot command directed at the first processor; and send the status indicative of the failure to comply with the zero downtime requirement of the application to the second processor before the first processor reboots.

Example 34 is at least one machine-readable medium including instructions that, when executed by processing circuitry, cause the processing circuitry to perform operations to implement of any of Examples 1-33.

Example 35 is an apparatus comprising means to implement of any of Examples 1-33.

Example 36 is a system to implement of any of Examples 1-33.

Example 37 is a method to implement of any of Examples 1-33.

Another example implementation is an edge computing system, including respective edge processing devices and nodes to invoke or perform the operations of Examples 1-33, or other subject matter described herein.

Another example implementation is a client endpoint node, operable to invoke or perform the operations of Examples 1-33, or other subject matter described herein.

Another example implementation is an aggregation node, network hub node, gateway node, or core data processing node, within or coupled to an edge computing system, operable to invoke or perform the operations of Examples 1-33, or other subject matter described herein.

Another example implementation is an access point, base station, roadside unit, street-side unit, or on-premises unit, within or coupled to an edge computing system, operable to invoke or perform the operations of Examples 1-33, or other subject matter described herein.

Another example implementation is an edge provisioning node, service orchestration node, application orchestration node, or multi-tenant management node, within or coupled to an edge computing system, operable to invoke or perform the operations of Examples 1-33, or other subject matter described herein.

Another example implementation is an edge node operating an edge provisioning service, application or service orchestration service, virtual machine deployment, container deployment, function deployment, and compute management, within or coupled to an edge computing system, operable to invoke or perform the operations of Examples 1-33, or other subject matter described herein.

Another example implementation is an edge computing system including aspects of network functions, acceleration functions, acceleration hardware, storage hardware, or computation hardware resources, operable to invoke or perform the use cases discussed herein, with use of Examples 1-33, or other subject matter described herein.

Another example implementation is an edge computing system adapted for supporting client mobility, vehicle-to-vehicle (V2V), vehicle-to-everything (V2X), or vehicle-to-infrastructure (V2I) scenarios, and optionally operating according to ETSI MEC specifications, operable to invoke or perform the use cases discussed herein, with use of Examples 1-33, or other subject matter described herein.

Another example implementation is an edge computing system adapted for mobile wireless communications, including configurations according to an 3GPP 4G/LTE or 5G network capabilities, operable to invoke or perform the use cases discussed herein, with use of Examples 1-33, or other subject matter described herein.

Another example implementation is an edge computing node, operable in a layer of an edge computing network or edge computing system as an aggregation node, network hub node, gateway node, or core data processing node, operable in a close edge, local edge, enterprise edge, on-premise edge, near edge, middle, edge, or far edge network layer, or operable in a set of nodes having common latency, timing, or distance characteristics, operable to invoke or perform the use cases discussed herein, with use of Examples 1-33, or other subject matter described herein.

Another example implementation is networking hardware, acceleration hardware, storage hardware, or computation hardware, with capabilities implemented thereupon, operable in an edge computing system to invoke or perform the use cases discussed herein, with use of Examples 1-33, or other subject matter described herein.

Another example implementation is an edge computing system configured to perform use cases provided from one or more of: compute offload, data caching, video processing, network function virtualization, radio access network management, augmented reality, virtual reality, industrial automation, retail services, manufacturing operations, smart buildings, energy management, autonomous driving, vehicle assistance, vehicle communications, internet of things operations, object detection, speech recognition, healthcare applications, gaming applications, or accelerated content processing, with use of Examples 1-33, or other subject matter described herein.

Another example implementation is an apparatus of an edge computing system comprising: one or more processors and one or more computer-readable media comprising instructions that, when executed by the one or more processors, cause the one or more processors to invoke or perform the use cases discussed herein, with use of Examples 1-33, or other subject matter described herein.

Another example implementation is one or more computer-readable storage media comprising instructions to cause an electronic device of an edge computing system, upon execution of the instructions by one or more processors of the electronic device, to invoke or perform the use cases discussed herein, with use of Examples 1-33, or other subject matter described herein.

Another example implementation is an apparatus of an edge computing system comprising means, logic, modules, or circuitry to invoke or perform the use cases discussed herein, with use of Examples 1-33, or other subject matter described herein.

Although these implementations have been described with reference to specific exemplary aspects, it will be evident that various modifications and changes may be made to these aspects without departing from the broader scope of the present disclosure. Many of the arrangements and processes described herein can be used in combination or in parallel implementations to provide greater bandwidth/throughput and to support edge services selections that can be made available to the edge systems being serviced. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

Such aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. An edge device comprising:
a processor to execute an application; and
a device including:
an interface to the processor;
a network interface; and
circuitry to:
monitor a status of the processor; and
based on the status and the application having an associated objective, initiate a migration of execution of the application from the processor.

2. The edge device of claim 1, wherein to initiate the migration, the circuitry is to send an indication to an orchestrator.

3. The edge device of claim 1, wherein the migration is to a second processor outside the edge device at a second edge device, the second edge device located within a communication threshold range.

4. The edge device of claim 1, wherein the migration is to a second processor outside the edge device at a cloud server.

5. The edge device of claim 1, wherein the migration is to the circuitry of the device.

6. The edge device of claim 1, wherein the interface to the processor includes a list of resources corresponding to the application.

7. The edge device of claim 1, wherein the status includes a scheduled downtime for the processor to perform an update.

8. The edge device of claim 1, wherein the status includes an unscheduled downtime for the processor due to a power failure.

9. The edge device of claim 1, wherein the processor is a central processing unit (CPU) and the device is one of an infrastructure processing unit (IPU), a data processing unit (DPU), or an edge processing unit (EPU).

10. The edge device of claim 1, wherein the edge device includes an event recorder device, the event recorder device including:
a battery to power the event recorder device; and
memory to store telemetry data captured by at least one sensor of the edge device.

11. The edge device of claim 10, wherein the event recorder device is activated when the edge device loses power.

12. The edge device of claim 10, wherein the at least one sensor includes at least one of a thermal sensor, a movement sensor, a pin in a device connector, an electric charge detector, or a pressure sensor.

13. The edge device of claim 1, wherein the edge device includes a baseboard management controller (BMC) to:
intercept a remote reboot command directed at the processor; and
send the status of the processor to the device before the processor reboots.

14. The edge device of claim 1, wherein the associated objective of the application includes a zero downtime requirement of the application.

15. At least one machine-readable medium, including instructions, which when executed by circuitry of a device of an edge device, cause the circuitry to perform operations to:
interface to a processor of the edge device executing an application;
communicate via a network interface to a second edge device;
monitor a status of the processor; and
based on the status and the application having an associated objective, initiate a migration of execution of the application from the processor.

16. The at least one machine-readable medium of claim 15, wherein the edge device includes an event recorder device, the event recorder device including:
a battery to power the event recorder device; and
memory to store telemetry data captured by at least one sensor of the edge device.

17. The at least one machine-readable medium of claim 15, wherein the associated objective of the application includes a zero downtime requirement of the application.

18. The at least one machine-readable medium of claim 15, wherein the processor is a central processing unit (CPU) and the device is one of an infrastructure processing unit (IPU), a data processing unit (DPU), or an edge processing unit (EPU).

19. A method comprising:
executing an application using a processor of an edge device;
interfacing, using circuitry of a device of the edge device, to the processor of the edge device;
communicating, using circuitry of the device, via a network interface to a second edge device;
monitoring, using circuitry of the device, a status of the processor; and
based on the status and the application having an associated objective, initiating, using circuitry of the device, a migration of execution of the application from the processor.

20. The method of claim 19, wherein initiating the migration includes executing the application at the circuitry of the device.
